(19) United States
(12) Patent Application Publication
(10) Pub. No.: US 2016/0325409 A1
(43) Pub. Date: Nov. 10, 2016

(54) Loose Nut the Right Tool

(71) Applicant: Real Joseph Lanteigne, Arroyo Grande, CA (US)

(72) Inventor: Real Joseph Lanteigne, Arroyo Grande, CA (US)

(21) Appl. No.: 14/708,202

(22) Filed: May 9, 2015

(51) Int. Cl. B25B 13/48; B25B 13/08

(52) U.S. Cl. CPC B25B 13/481; B25B 13/08

(57) ABSTRACT

A tool that provides users with the ability to assemble and disassemble a faucet connection in any location, regardless of space constraints to create a more ergonomic tool in assisting with faucet hookups.

### DETAILED DESCRIPTION

As discussed above, embodiments of the present invention relate to a plumbing wrench tool device and more particularly to a Loose Nut the Right Tool a tool that provides users with the ability to assemble and disassemble a faucet connection in any location, regardless of space constraints to create a more ergonomic tool in assisting with faucet hookups.

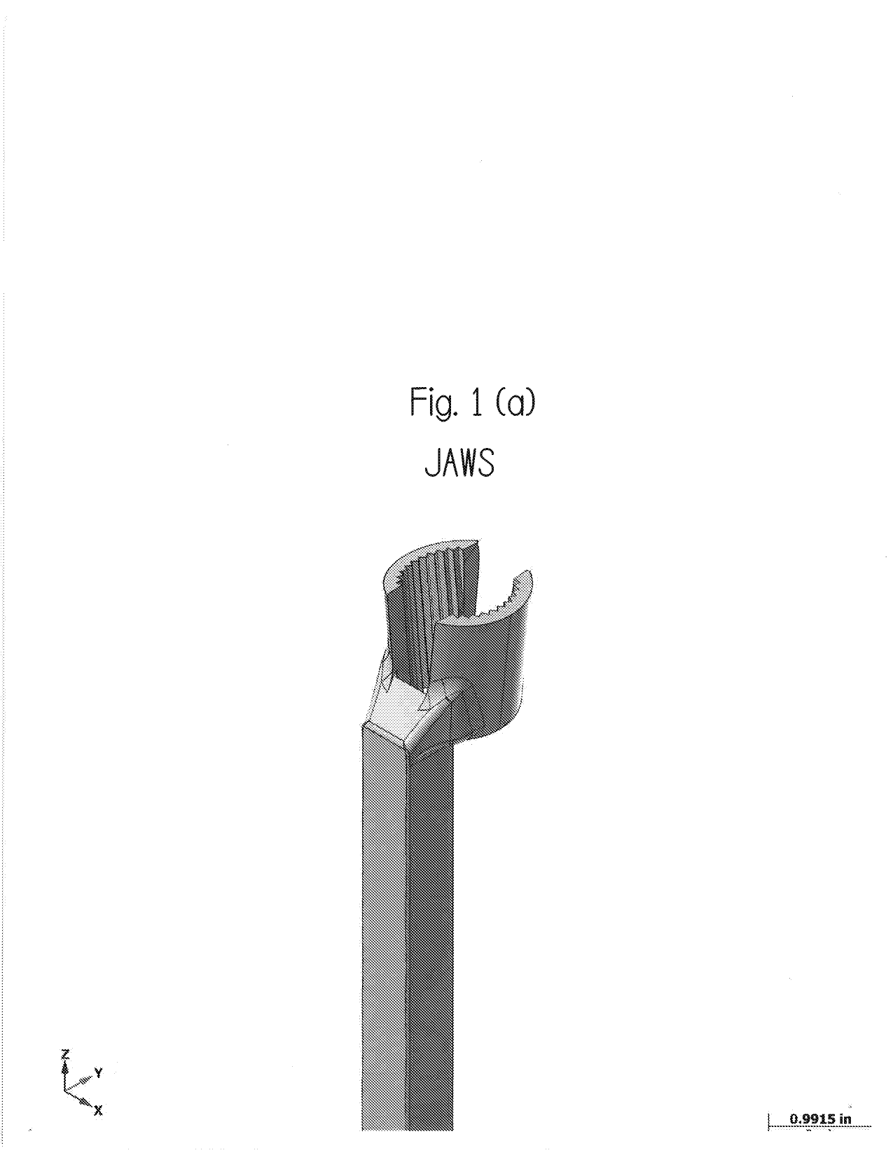

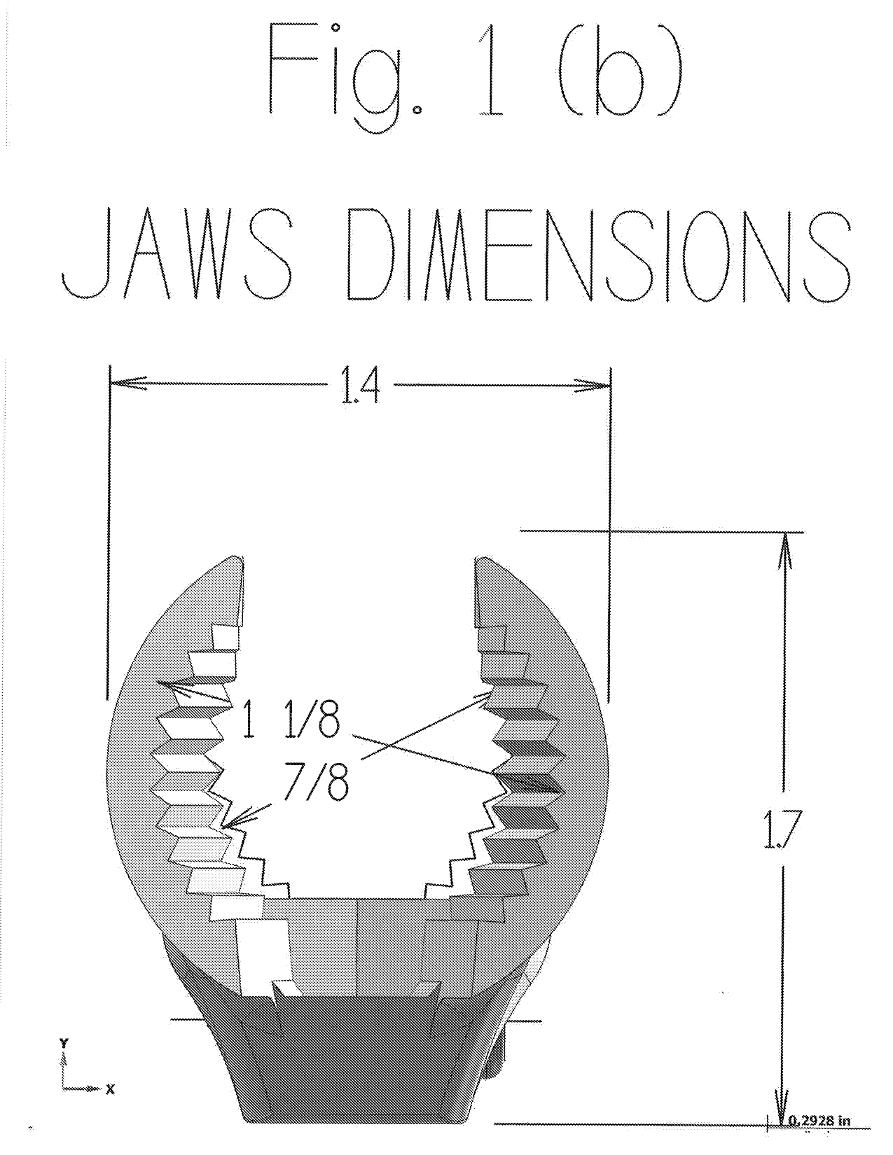

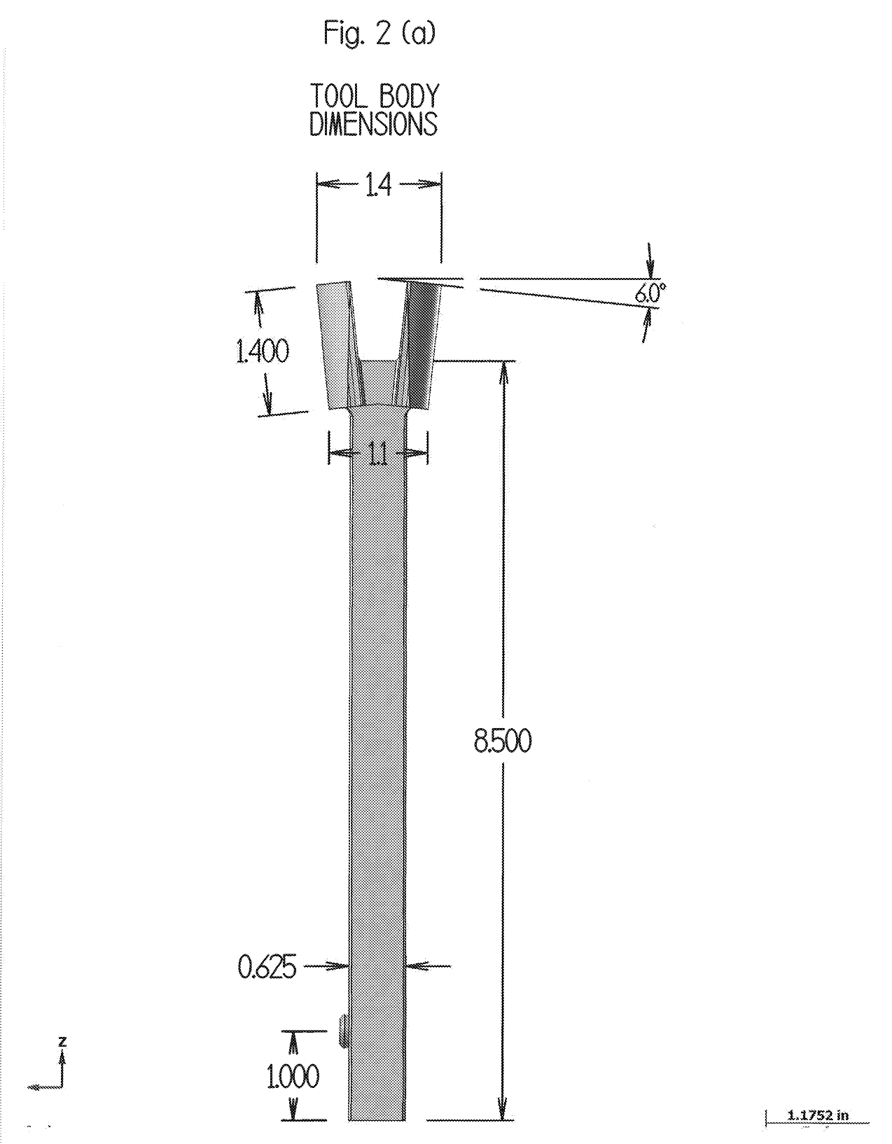

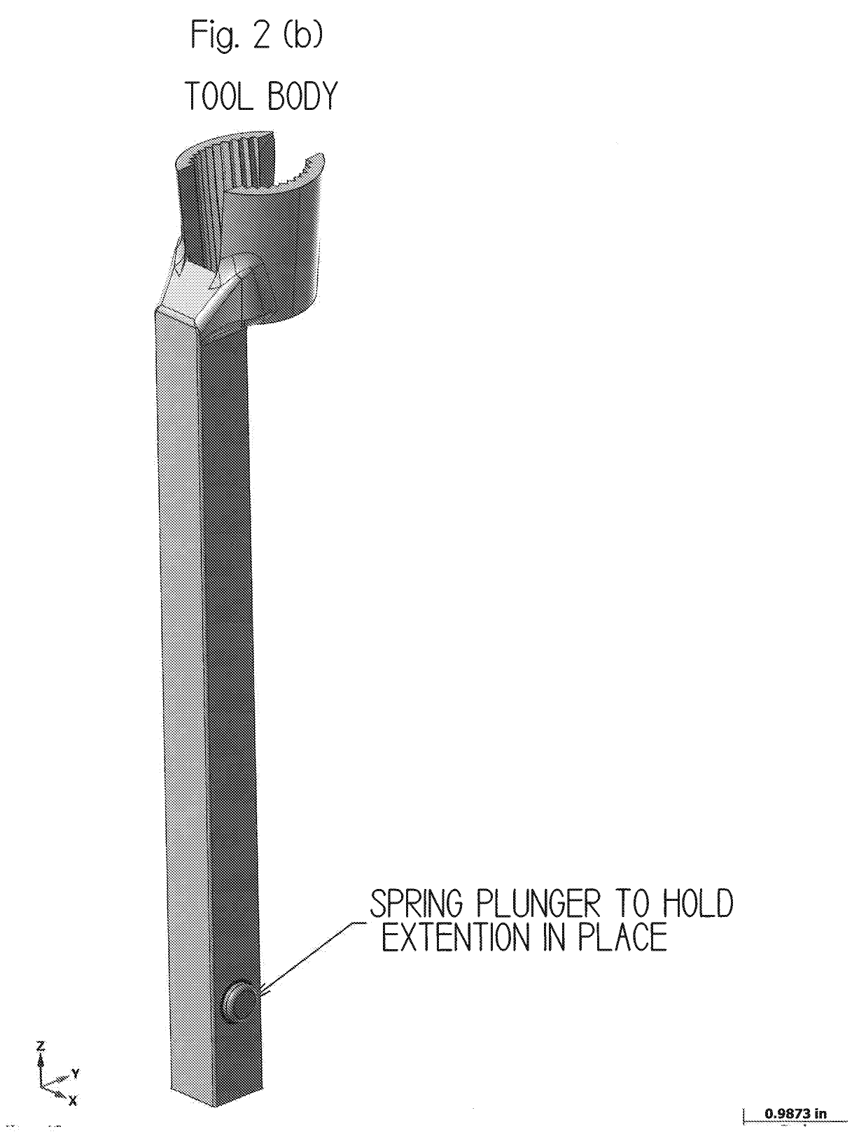

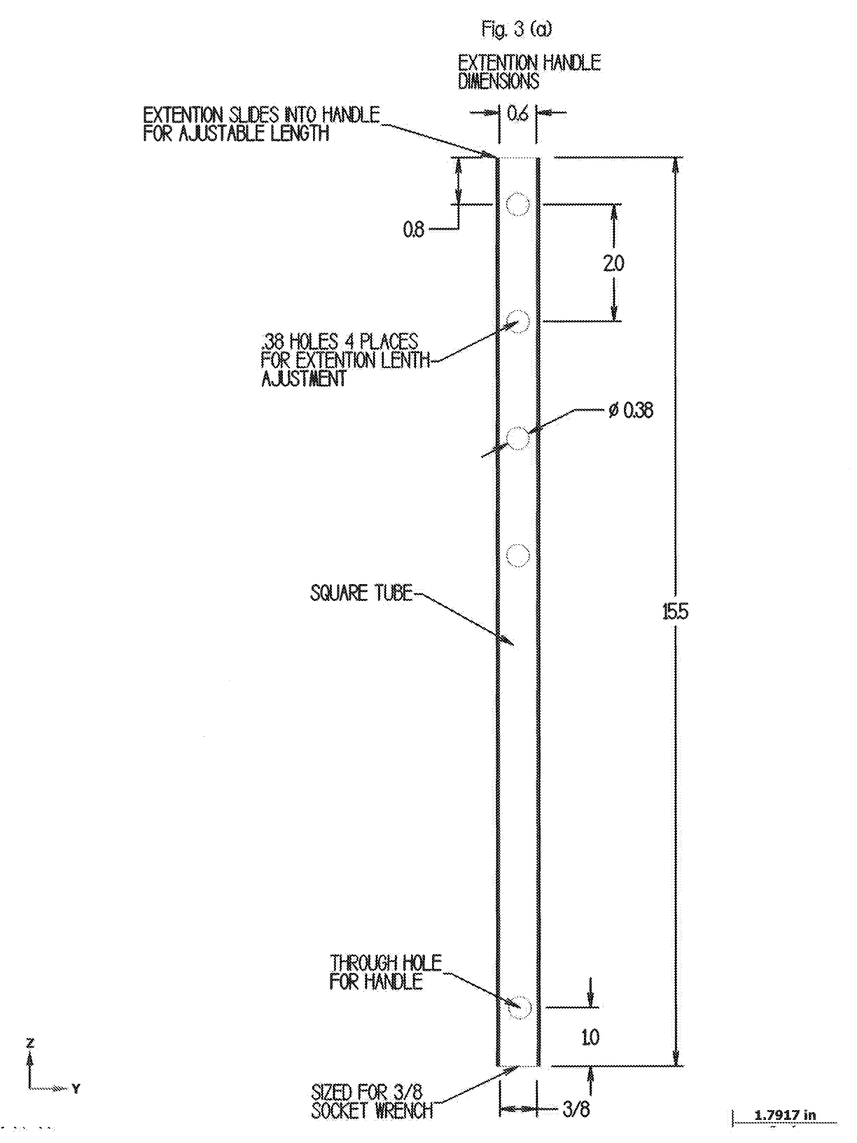

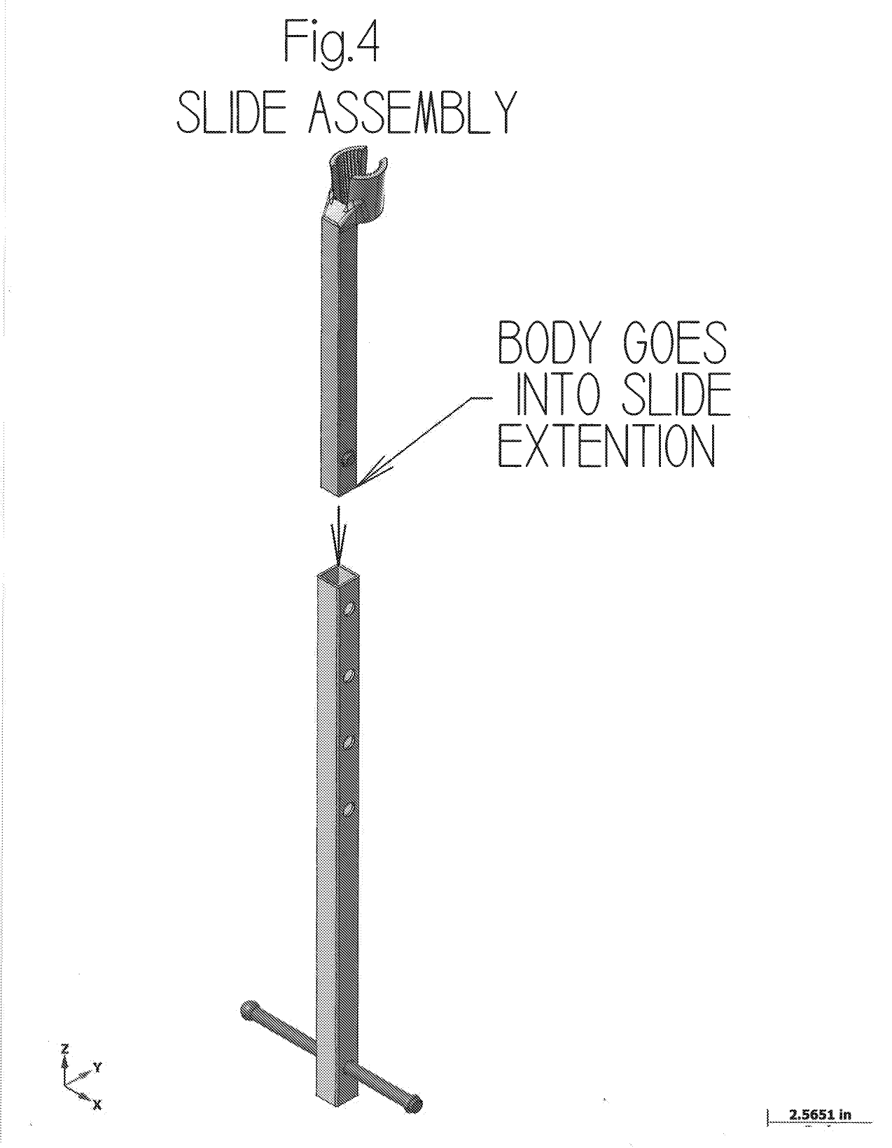

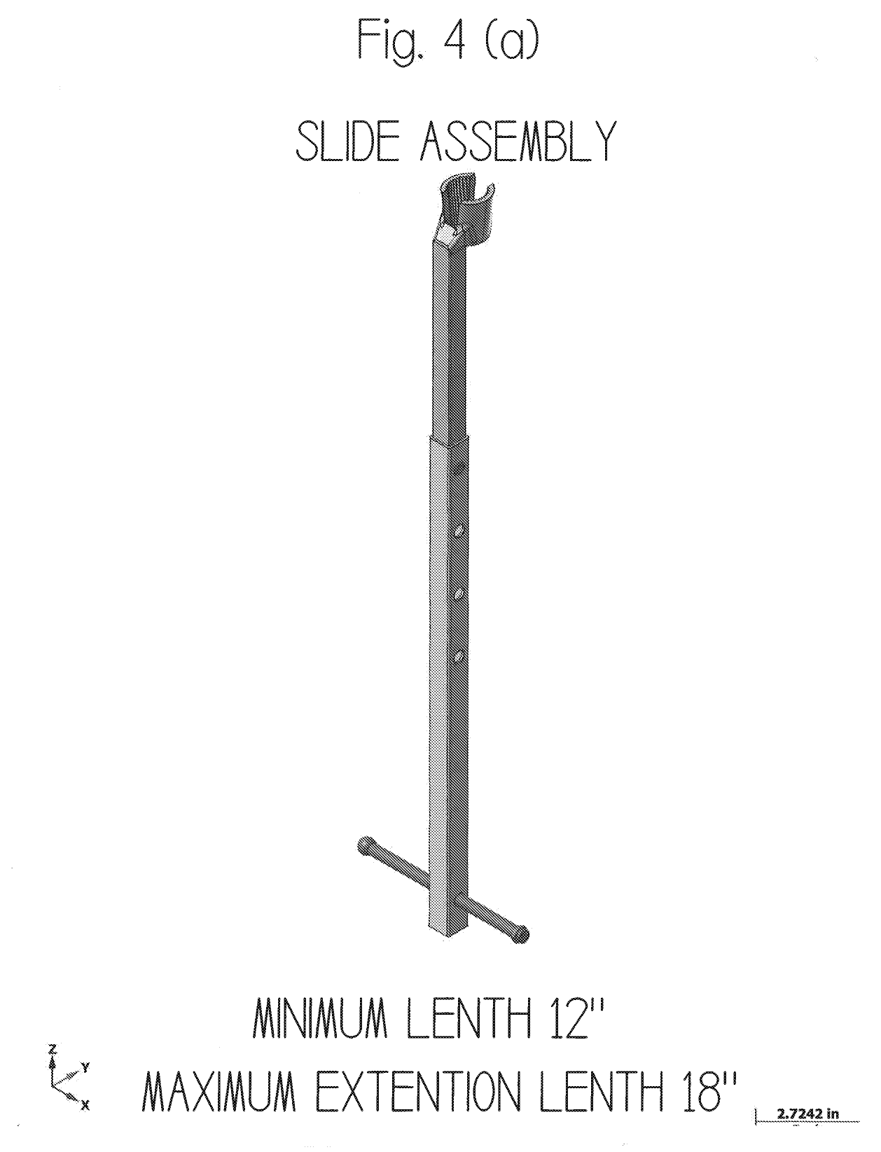

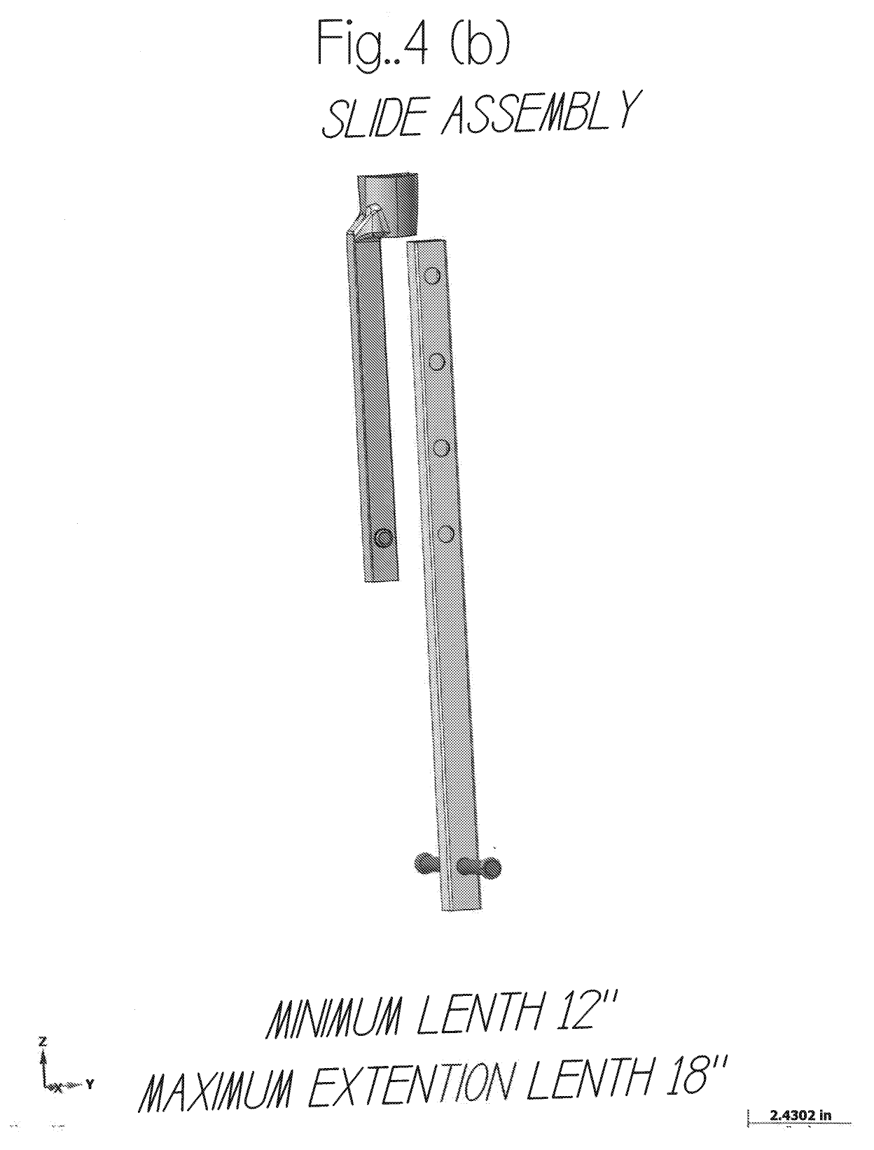

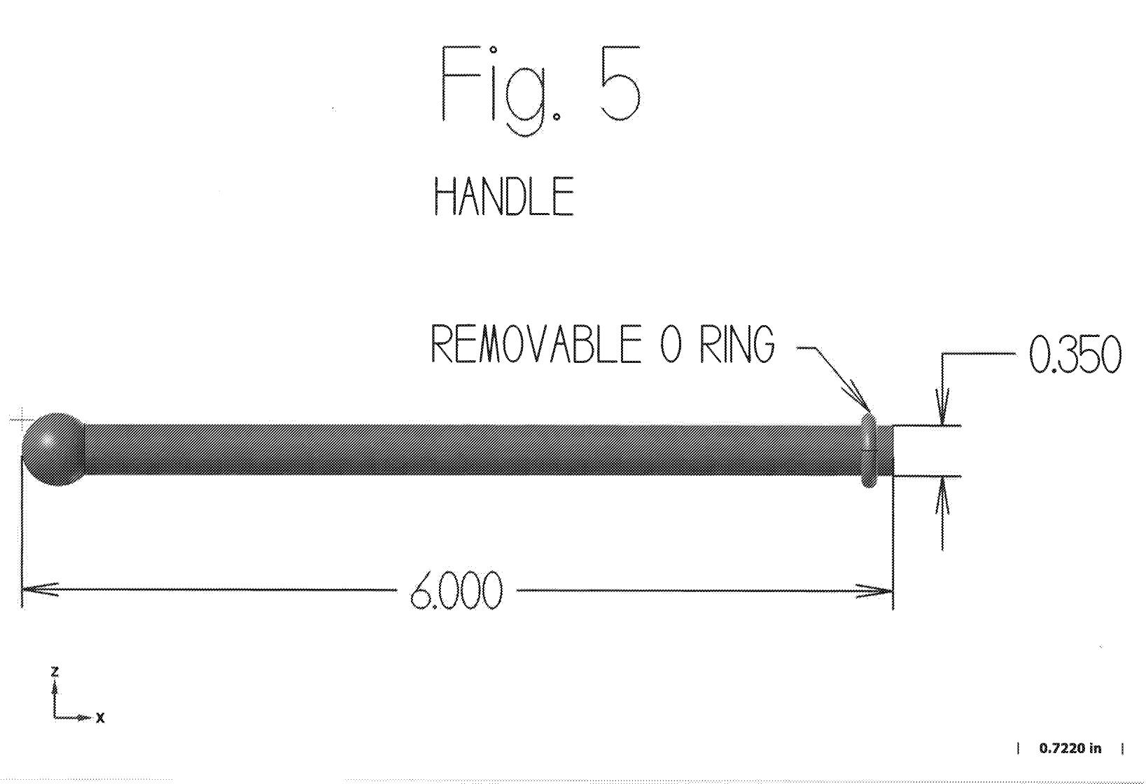

Referring now to the drawings FIG. 1, the Loose Nut the Right Tool comprising a novel product offering consumers a practical solution to the aforementioned challenges. As the name implies, the Loose Nut the Right Tool comprises a specially designed wrench since most under-counter installations of feed lines to faucets require a firm, tight grip that avoids the feed line and can be maneuvered in extremely close quarters, he designed the Loose Nut The Right Tool to satisfy all these considerations while at the same time remaining interoperable between both old-style brass fittings and modern stainless-steel ones.

Loose Nut—The Right Tool is a thin, solid hand tool composed of dropforged steel. It features a knurled handle at one end, and the other tapers to a small head where the device's specialized shape is positioned. The head is divided into two lobes that extend forward from the device's end, and curve in towards one another, so as to create an enclosed cylinder with two open, empty walls. The gap between the two lobes is large enough for a standard-gauge water feed line to easily slide through, and the curve of the lobes themselves is appropriate to snugly surround a regular hose-end nut. Both of these curved jaws are toothed on the inside, allowing them to easily mesh with the hose-end nut when the device is in place. These “jaws” are slightly wider apart at the top, and narrow closer to the shaft. This enables the Loose Nut—the Right Tool to easily maneuver both older brass hose-end nuts, and newer, hexagonal stainless-steel hose-end nuts. The device is seventeen-and-one-half-inches long, and also includes an additional nine and-one-half-inch extension that connects to the end of the handle.

Combined, the two measure twenty three inches, providing a sufficient length which to exert significant force to tighten or loosen the nuts involved. The device can be used without the extension connected, but a small crescent wrench or other source to increase torque and leverage may be required. The outside diameter of the tool head wraps around the hose-end nut with very little overlap, maintaining a uniquely compact profile that makes installation in even the tightest areas simple. While other devices traditionally used for securing these nuts require a full two and a half inches of clearance, the Loose Nut—The Right Tool performs the same function in only one and three eighths of an inch. By minimizing the space required to achieve a snug, secure fit, the Loose Nut—The Right Tool provides users with the ability to assemble and disassemble a reliable faucet connection in any location, regardless of-space constraints.

With the water off, the head end of the Loose Nut -The Right Tool can slide around the supply hose, with one jaw lobe on either side. Connecting a new feed hose to a faucet using the Loose Nut—The Right Tool involves using the tool as a handle with which to lift the hose-end nut up into location, and then apply the appropriate torque. Approaching the underside of the faucet from within whatever cabinet or housing will contain the plumbing, extend the Loose Nut—The Right Tool with the hose in place between the jaws and the hose-end nut securely enmeshed in the device's teeth. At this point, you may wish to add the extension to the end of the handle, should you need a greater reach to set the nut into place on the faucet bottom. Once the nut is located in the correct location and orientation with regards to the faucet, the operator need simply twist the device clockwise to secure the nut in place.

Continuing to twist until the nut offers no more play, will ensure that a sufficiently tight seal is created. With the Loose Nut -The Right Tool, removal of the feed lines connected to an old faucet is equally convenient. Also, if the nut is heavily corroded and offers significant resistance, or if the working space is especially limiting of one's movements, the extension (⅜ ratchet socket drive) can be fitted to the end of the handle ratchet opening, providing an easy way to exert increased torque against the fitting. (Complete instructions and recommendations will be furnished with purchase.)

The Loose Nut—The Right Tool offers a serious ergonomic and safe-use benefit over the current tools used by professional plumbers and home repair fans to connect and remove feed hoses from the underside fittings of faucets. It does so by providing a simple way to apply rotating force to the hose-end nuts used to affix water supply lines to faucets, a way the avoids the slipped tools and banged knuckles usually associated with such procedures. It offers a greatly reduced space tolerance required for such undertakings, allowing for much tighter, denser designs that maximize the use of under-counter space for utilities. Loose Nut -The Right Tool is a device that should be in every plumber's tool box and in every home DIY tool kit. It provides a simple solution to a vexing technical problem, with an economical form and a solid robustness. Cleverly conceived, the Loose Nut—The Right Tool should be enthusiastically received by a wide market. The Loose Nut the Right Tool is cost-effective to produce in the embodiments, as shown in FIG. 1.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A plumbing wrench tool for use in hard-to-reach areas essentially as described herein.
